(19) United States
(12) Patent Application Publication
(10) Pub. No.: US 2025/0141234 A1
(43) Pub. Date: May 1, 2025

(54) SYSTEMS AND METHODS FOR NON-ITERATIVE DISTRIBUTED POWER FLOW EVALUATION FOR RADIAL SYSTEMS

(71) Applicant: Amarsagar Reddy Ramapuram Matavalam, Tempe, AZ (US)

(72) Inventor: Amarsagar Reddy Ramapuram Matavalam, Tempe, AZ (US)

(73) Assignee: Arizona Board of Regents on Behalf of Arizona State Unviersity, Tempe, AZ (US)

(21) Appl. No.: 18/934,057

(22) Filed: Oct. 31, 2024

Related U.S. Application Data
(60) Provisional application No. 63/594,876, filed on Oct. 31, 2023.

(51) Int. Cl. H02J 3/38

(52) U.S. Cl. CPC H02J 3/381; H02J 2203/10; H02J 2203/20

(57) ABSTRACT

A computer-implemented system and associated methods solve a power flow problem on radial power distribution networks with ZIP loads and other distributed energy resources in a non-iterative and matrix free manner and without the need for an initial guess. The system converts implicit equations that arise in the power flow equations into an appropriate 1-dimensional explicit functional representation to sequentially eliminate voltages in a radial power distribution network.

### CROSS-REFERENCE TO RELATED APPLICATIONS

This is a U.S. Non-Provisional Patent Application that claims benefit to U.S. Provisional Patent Application Ser. No. 63/594,876 filed 31 Oct. 2023, which is herein incorporated by reference in its entirety.

### FIELD

The present disclosure generally relates to power flow monitoring in distributed energy systems, and in particular, to power flow monitoring and evaluation for radial distributed energy systems having ZIP loads and other grid components including generators, shunts, and renewable inverters.

### BACKGROUND

Solving the power flow problem on distribution systems plays an important role in the planning and operations of the power grid. As the power flow problem is inherently nonlinear, iterative methods are typically employed in the solution process. However, iterative methods can identify spurious solutions or can diverge due to numerical instabilities. Additionally, most conventional methods use sparse linear solvers that are unable to exploit the increasing compute capability available in devices such as graphics processing units (GPUs) and tensor processing units (TPUs). Traditional approaches in power grid analysis use sparse linear solvers that are unable to fully leverage non-Von Neumann architecture (NVNA). Other methods that avoid shortcomings in traditional approaches cannot reliably avoid nonsingularities or approximations of irrational numbers.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is a schematic diagram showing key notations of a radial power distribution system as outlined herein;

FIG. 2 is a schematic diagram showing an example of a 3-bus radial power distribution system;

FIG. 3 is a schematic diagram showing a generalized representation of a radial power distribution system;

FIG. 4 is a graphical representation showing a Distributed Energy Resource (DER) Volt-VAR control curve for when the radial power distribution system includes a renewable inverter at node-i;

FIG. 5A is a simplified diagram showing a system for evaluating voltage magnitude and angle for nodes of a radial power distribution system;

FIG. 5B is a simplified diagram illustrating an example “backward pass” implemented by the system of FIG. 5A with respect to a radial power distribution system;

FIG. 5C is a simplified diagram illustrating an example “forward pass” implemented by the system of FIG. 5A with respect to a radial power distribution system;

FIG. 6 is a diagram illustrating an example computing system for implementation of the system of FIGS. 5A-5C;

FIGS. 7A and 7B are a pair of process flow diagrams respectively showing an example backward pass and an example forward pass correlating with FIGS. 5B and 5C;

FIG. 8 is a schematic diagram showing an example 5-bus radial power distribution system partitioned into information considered by a plurality of computing elements;

FIG. 9 is a graphical representation showing voltage functions vᵢ^{f(v}^{ₚ₍ᵢ₎}⁾ for the 5-bus system of FIG. 8 with ZIP parameters [0.1, 0.1, 0.8] dominated by constant power load;

FIG. 10 is a graphical representation showing voltage functions vᵢ^{f(v}^{ₚ₍ᵢ₎}⁾ for the 5-bus system of FIG. 8 with ZIP parameters [0.1, 0.8, 0.1] dominated by current;

FIG. 11 is a graphical representation showing voltage functions vᵢ^{f(v}^{ₚ₍ᵢ₎}⁾ for the 5-bus system of FIG. 8 with ZIP parameters [0.8, 0.1, 0.1] dominated by impedance load; and

FIG. 12 is a graphical representation showing voltage functions vᵢ^{f(v}^{ₚ₍ᵢ₎}⁾ for a 564-bus system with ZIP load coefficients [0.2, 0.2, 0.6].

Corresponding reference characters indicate corresponding elements among the view of the drawings. The headings used in the figures do not limit the scope of the claims.

### DETAILED DESCRIPTION

Solving the power flow problem on radial systems plays an important role in the planning and operations of the power grid. As the power flow problem is inherently non-linear, iterative methods are typically employed in the solution process. These methods can converge to spurious solutions or can diverge due to numerical instabilities if the initial guess is improper. The present disclosure outlines a system and associated methods can solve the power flow problem on radial networks with grid components such as ZIP loads, generators, shunts, and renewable inverters in a non-iterative and matrix free manner and without the need for an initial guess. This is possible by converting the implicit equations that arise in the power flow equations into an appropriate explicit functional representation to sequentially eliminate voltages in the grid. The existence of voltage functions in radial networks is proved and an efficient method to estimate these functions in a distributed manner is described. The method is tested on all radial test cases in MATPOWER, and the results validate its accuracy.

### 1. Introduction

The power flow equations describe the balance and flow of power in a power system. These are non-linear equations, and the flows are coupled through the network topology. Thus, solving the power flow involves finding a solution to a set of non-linear systems of equations. There is rich literature on efficiently solving these equations for radial systems, which is the focus of this disclosure.

The commonly used approach is the backward-forward sweep (BFS) method, whose simplicity and distributed nature make it easily implementable in modern computing architectures, including GPUs. However, it is iterative in nature and has poor convergence properties as a result of its sensitivity to ZIP load model parameters and the initial solution guess. More advanced methods use variations of the Newton-Raphson method on different formulations of the power flow problems. A few recent works have looked at linearizing the power flow equations with certain guarantees, but the linearization is only valid over a region of power injections.

To overcome the problem of the Newton-based methods, non-diverging methods have been proposed. However, all of them involve sparse matrix solvers, making them challenging and inefficient to implement in emerging high-performance computing hardware that are not suitable for sparse matrix computations. The present disclosure outlines a novel non-diverging matrix-free distributed power flow solver based on the idea of elimination functions that are amenable for deploying on distributed computing architecture. The systems and methods outlined herein pertain to balanced radial distribution systems with grid components such as ZIP loads, generators, shunts, and renewable inverters, which can be represented using a single-phase positive sequence model. The key contributions of this disclosure include:

A novel approach for solving the power flow in a radial system with ZIP loads using voltage functions.

An efficient matrix-free distributed method to estimate the voltage functions and the bus voltages.

Implementing and validating the functional power flow results for multiple radial test systems in MATPOWER.

The remainder of the disclosure is organized as follows. Section II introduces the distribution system model used throughout this disclosure. Section III introduces the concept of voltage functions in radial networks. Section IV presents the functional power flow methods utilizing the concept of voltage functions. Numerical results are presented in Section V, and the work concludes with Section VI.

### II. Preliminaries and System Model

This section of the disclosure establishes mathematical notation used to describe the power flow equations on a radial distribution system. Due to terminology conventions, the terms bus (resp. line) and node (resp. edge) are used interchangeably.

### A. Preliminaries

Consider a radial distribution system having nodes {0,1, . . . , n}∈ [symbol] and edges {1, . . . , n}∈ [symbol] . The node-0 is usually referred to as the substation, as it connects the distribution system with the transmission system. Because of the radial nature of the grid, the number of branches is equal to the number of nodes less one. The nodes are numbered in the topological order of their distance from the substation node using oriented ordering. Each node i∈ [symbol] has a unique parent node denoted by p(i) and can have multiple children nodes. The depth first ordering ensures that k≥i+1∀k∈c(i), i∈ [symbol] . The set of children of node i is denoted by c(i). The edges are numbered so that edge i (denoted by eᵢ) connects node p(i) and node i.

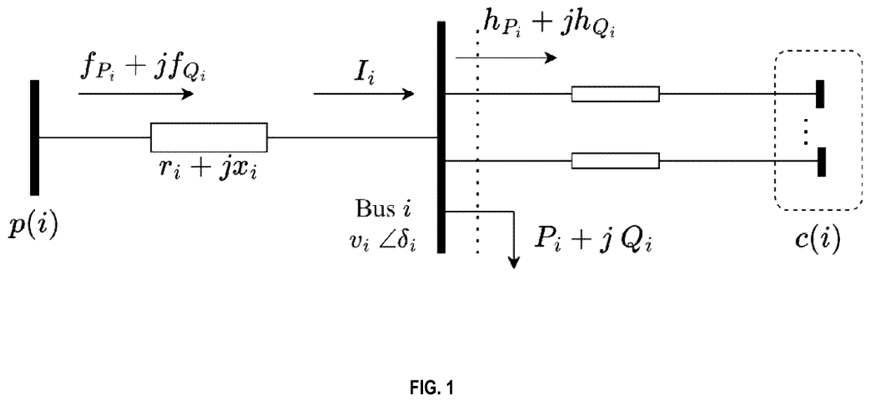

Some of the notations introduced below are depicted in FIG. 1. For each node i∈ [symbol] , let Vᵢ=vᵢ<δᵢ be a line-to-ground voltage phasor, where vᵢ is a voltage magnitude and δᵢ is a voltage angle with respect to the root node. Thus δ₀=o. For each branch eᵢ∈ [symbol] , let rᵢ+jxᵢ=zᵢ<ϕᵢ be its complex impedance, where zᵢ is the magnitude of the line impedance and ϕᵢ is the angle of the line impedance. Let ψₚ₍ᵢ₎ᵢ:=δₚ₍ᵢ₎−δᵢ be the relative phase of the node voltage Vᵢ with respect to its parent node.

Assuming all the nodes i∈ [symbol] are PQ buses with a ZIP load is connected that extracts complex power, which is a function of node voltage given by Sᵢ=Pᵢ+jQᵢ=(μ_{Z}_{ᵢ}·vᵢ²+μ_{I}_{ᵢ}·vᵢ+μ_{P}_{ᵢ})(Pₙ_{ᵢ}+jQₙ_{ᵢ}) from the grid. Wherein μ_{Z}_{ᵢ}, μ_{I}_{ᵢ}, and μ_{P}_{ᵢ} are the ZIP fractions that specify the constant impedance, constant current and constant power proportion of the nominal load (Pₙ_{ᵢ}+jQₙ_{ᵢ}) at node i.

The active and reactive power flows in edge eᵢ∈ [symbol] are denoted as f_{P}_{ᵢ} and f_{Q}_{ᵢ} as measured from the node p(i). The complex current flow through line eᵢ from node p(i) to node i is denoted by Iᵢ. The aggregated active and reactive power of the grid as observed by node i∈ [symbol] is given by the sum of flows on each line to its children nodes along with the load demand and is denoted by h_{P}_{ᵢ} and h_{Q}_{ᵢ}. For leaf nodes, i.e., i∈ [symbol] such that |c(i)|=0, h_{P}_{ᵢ}=Pᵢ and h_{Q}_{ᵢ}, =Qᵢ.

### III. Power Flow Using Voltage Functions

The objective of the distribution power flow is to estimate all the node voltage magnitudes and angles. The parameters available to solve the power flow problem are the substation voltage and the complex power demand at each node. The substation location is considered a reference bus, as given by (1). This assumes the voltage at the substation is constant, and the equation for the substation voltage is (1).

$${V}_{0} = {v}_{sub} ∠0 \qquad ( 1 )$$

The power flowing in a branch of the radial distribution system can be written as a function of the node voltages at the line terminals as given in (2). Any node in the system may include a load and multiple branches that connect it to different nodes c(i), as shown in FIG. 1. Therefore, the general expression of the total complex power supplied by the bus is given in (3). Finally, the voltage at the sending end of a line can be expressed as a function of the receiving end voltage using KVL in (4).

$${f}_{{P}_{i}} + {jf}_{{Q}_{i}} = {{V}_{p ( i )} ( \frac{{V}_{p ( i )} - {V}_{i}}{{r}_{i} + {jx}_{i}} )}^{*} ∀ i ∈ N \qquad ( 2 )$$

$${h}_{{P}_{i}} + {jh}_{{Q}_{i}} = ( {P}_{i} + {jQ}_{i} ) + {\sum }_{k ∈ c ( i )} ( {f}_{{P}_{k}} + {jf}_{{Q}_{k}} ) \qquad ( 3 )$$

$${V}_{p ( i )} = {V}_{i} + ( {r}_{i} + {jx}_{i} ) {( \frac{{h}_{{P}_{i}} + {jh}_{{Q}_{i}}}{{V}_{i}} )}^{*} \qquad ( 4 )$$

Upon substituting (2) and (3) into (4), two functions can be obtained: one is an implicit function that relates the voltage magnitudes, vₚ₍ᵢ₎ and vᵢ. The other function expresses the bus voltage angle difference, ψₚ₍ᵢ₎ᵢ in terms of the voltage magnitude, vₚ₍ᵢ₎ explicitly. One-dimensional interpolation is used to obtain an explicit representation of the implicit function, f(vₚ₍ᵢ₎, vᵢ)=0. The obtained explicit function for vᵢ as a function of vₚ₍ᵢ₎ is represented as vᵢ=vᵢ^{f(v}^{ₚ₍ᵢ₎}⁾.

Similarly, another equivalent explicit function can be obtained as ψₚ₍ᵢ₎ᵢ≡ψₚ₍ᵢ₎ᵢ^{g(v}^{ₚ₍ᵢ₎}⁾, which relates the bus voltage angle difference ψₚ₍ᵢ₎ᵢ between bus i and bus p(i) as a function of voltage magnitude, vₚ₍ᵢ₎ using one-dimensional interpolation. These interpolated functions can be obtained for all the nodes in a radial system as a function of its parent bus voltage magnitudes. The estimation of functions starts from the leaf nodes and propagates up to the substation bus and is called the “backward pass”. Starting from the children bus of the substation bus, the voltage magnitudes of parent nodes are substituted into the node voltage functions one after another to obtain the voltages at all nodes, and this process is called “forward pass”. The method is explained with a 3-bus example in the subsection below.

### A. Functional Power Flow of 3-Bus Radial System

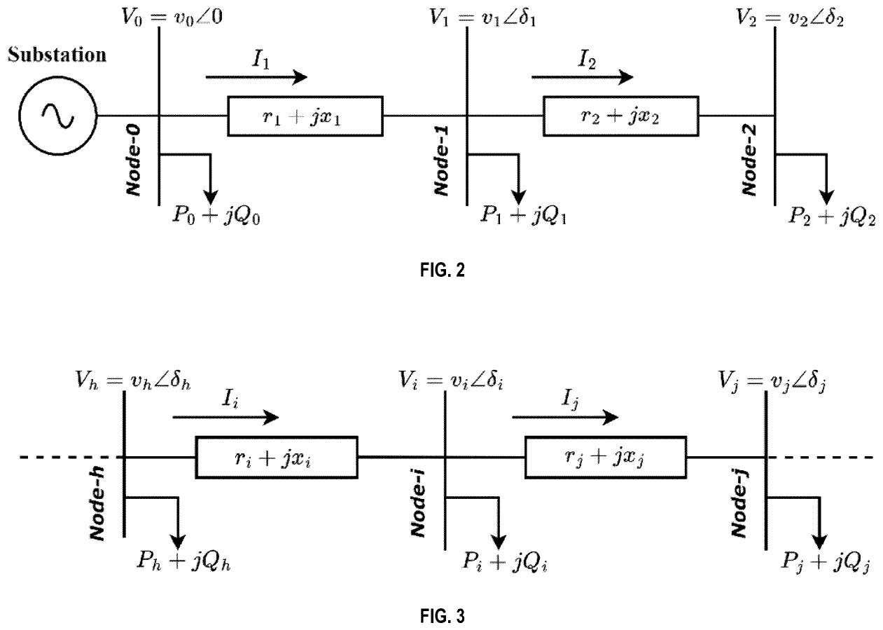

The proposed functional power flow method is explained using a 3-bus radial system with ZIP loads connected at each bus as shown in FIG. 2. The KCL and KVL equations for the 3-bus radial system are given in (5) and (6).

$$\begin{matrix}{v}_{0} {∠ψ}_{01} = {v}_{1} + {I}_{1} ( {r}_{1} + {jx}_{1} ) \\ {v}_{1} {∠ψ}_{01} = {v}_{1} + {I}_{1} ( {r}_{2} + {jx}_{2} )\end{matrix} \qquad ( 5 )$$

$$\begin{matrix}{I}_{1} = \frac{{P}_{1} - {jQ}_{1}}{{v}_{1}} + \frac{{v}_{1} - {v}_{2}^{f ( {v}_{1} )} ∠ - {ψ}_{12}^{g ( {v}_{1} )}}{{r}_{2} + {jx}_{2}} \\ {I}_{2} = \frac{{P}_{2} - {jQ}_{2}}{{v}_{2}}\end{matrix} \qquad ( 6 )$$

In (6), the complex powers (P₁−jQ₁) and (P₂−jQ₂) represent the ZIP loads, and their magnitudes are dependent on the respective node voltages. The terms v₂^{f(v}^{₁}⁾ is the voltage magnitude of node-2, and ψ₁₂^{g(v}^{₁}⁾ is the voltage angle of node-2 with reference to its parent node, i.e., node-1. These voltage and angle terms are expressed as v₁ functions.

The implicit relation between node-1 and node-2 voltage magnitudes is given by (7). It is obtained by substituting (6) into (5). The obtained functions are approximated into equivalent explicit functions as v₂=v₂^{f(v}^{₁}⁾ and ψ₁₂=ψ₁₂^{g(v}^{₁}⁾. These approximated explicit functions of node-2 are to be substituted in the I₁ equation to obtain the node-1 voltage and angle functions as given in (8). This process continues further up to the substation bus or node-0. Since node-0 is the reference bus, its voltage phasor is one of the inputs to the power flow problem. Therefore, the set of equations used to represent the other node voltages is not required to represent node-0 voltage.

### 1) Voltage Magnitude and Angle Functions of Node-2

$$\begin{matrix}0 = {( {v}_{1} {v}_{2} )}^{2} - {( {v}_{2}^{2} + {P}_{2} {r}_{2} + {Q}_{2} {x}_{2} )}^{2} - {( {P}_{2} {x}_{2} - {Q}_{2} {r}_{2} )}^{2} \\ {ψ}_{12} = {tan}^{- 1} ( \frac{{P}_{2} {x}_{2} - {Q}_{2} {r}_{2}}{{v}_{2}^{2} + {P}_{r} {r}_{2} + {Q}_{2} {x}_{2}} )\end{matrix} \qquad ( 7 )$$

### 2) Voltage Magnitude and Angle Functions of Node-1

$$\begin{matrix}0 = {( {v}_{0} {v}_{1} )}^{2} - {( {v}_{1}^{2} + {h}_{{P}_{1}} {r}_{1} + {h}_{{Q}_{1}} {x}_{1} )}^{2} - {( {h}_{{P}_{1}} {x}_{1} - {h}_{{Q}_{1}} {r}_{1} )}^{2} \\ {ψ}_{12} = {tan}^{- 1} ( \frac{{h}_{{P}_{1}} {x}_{1} - {h}_{{Q}_{1}} {r}_{1}}{{v}_{1}^{2} + {h}_{{P}_{1}} {r}_{1} + {h}_{{Q}_{1}} {r}_{1}} )\end{matrix} \qquad ( 8 )$$

Where

$$\begin{matrix}{h}_{{P}_{1}} = {P}_{1} + \frac{{v}_{1}^{2} cos ( {ϕ}_{2} ) - {v}_{1} {v}_{2}^{f ( {v}_{1} )} cos ( {ϕ}_{2} + {ψ}_{12}^{g ( {v}_{1} )} )}{{Z}_{1}} \\ {h}_{{Q}_{1}} = {Q}_{1} + \frac{{v}_{1}^{2} sin ( {ϕ}_{2} ) - {v}_{1} {v}_{2}^{f ( {v}_{1} )} sin ( {ϕ}_{2} + {ψ}_{12}^{g ( {v}_{1} )} )}{{Z}_{2}} \\ {Z}_{2} {∠ϕ}_{2} = {r}_{2} + {jx}_{2}\end{matrix}$$

Once each bus voltage and angle is approximated as an equivalent explicit function of its parent bus voltage magnitude, the voltage magnitude and angle of all the nodes can be obtained in the forward pass. The starting point for the forward pass is the children node of the substation bus since substation voltage is an input parameter in the power flow problem.

### B. General Expressions for Node Voltage Magnitude and Angle Functions

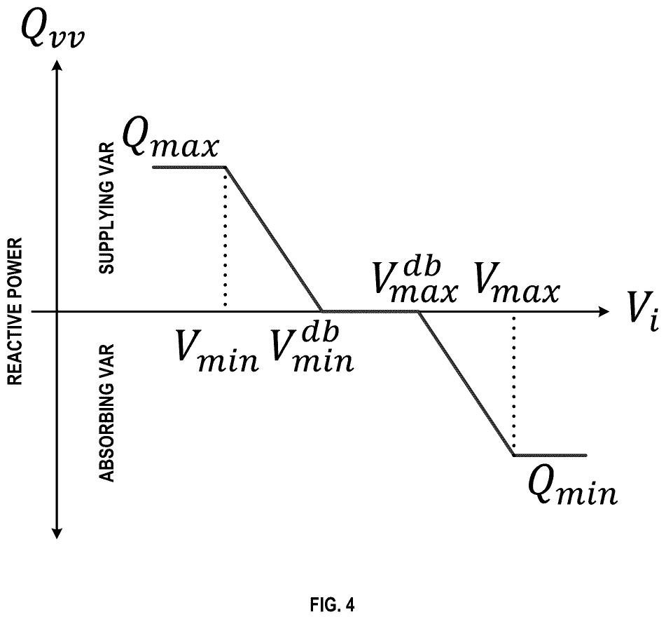

The generalized expressions to obtain the voltage of any bus of a radial distribution system shown in FIG. 3 are given in (9). In FIG. 3, the parent node and children node are represented as h and j instead of p(i) and c(i), respectively, for simplicity.

$$\begin{matrix}0 = {( {v}_{h} {v}_{i} )}^{2} - {( {v}_{i}^{2} + {h}_{{P}_{i}} {r}_{i} + {h}_{{Q}_{i}} {x}_{i} )}^{2} - {( {h}_{{P}_{i}} {x}_{i} - {h}_{{Q}_{i}} {r}_{i} )}^{2} \\ {ψ}_{hi} = {tan}^{- 1} ( \frac{{h}_{{P}_{i}} {x}_{i} - {h}_{{Q}_{i}} {r}_{i}}{{v}_{1}^{2} + {h}_{{P}_{i}} {r}_{i} + {h}_{{Q}_{i}} {r}_{i}} )\end{matrix} \qquad ( 9 )$$

Where:

$$\begin{matrix}{h}_{{P}_{i}} = {P}_{i} + \frac{{v}_{i}^{2} cos ( {ϕ}_{j} ) - {v}_{i} {v}_{j}^{f ( {v}_{i} )} cos ( {ϕ}_{j} + {ψ}_{ij}^{g ( {v}_{i} )} )}{{Z}_{j}} \\ {h}_{{Q}_{i}} = {Q}_{i} + \frac{{v}_{i}^{2} sin ( {ϕ}_{j} ) - {v}_{i} {v}_{j}^{f ( {v}_{i} )} sin ( {ϕ}_{j} + {ψ}_{ij}^{g ( {v}_{i} )} )}{{Z}_{2}} \\ {Z}_{j} {∠ϕ}_{j} = {r}_{j} + {jx}_{j}\end{matrix} \qquad ( 10 )$$

The first power terms of h_{P}_{ᵢ}, and h_{Q}_{ᵢ}, in (10) refer to the ZIP load powers connected to the node-i, and the second refers to the power flows through the child branch connected to the node-i.

Remark: In the formulation discussed so far, there is only one outgoing branch at each node, but in practice, multiple branches can connect to multiple children nodes from a single parent node as shown in FIG. 1. In that case, the only change occurs in the h_{P}_{ᵢ}, and h_{Q}_{ᵢ}, expressions in (10) in which all the child branch power flow terms connecting the node-i and its children nodes are combined as given in (3). The generalized method for the functional power flow of a radial distribution system is presented in the next section.

### C. Modifications for Alternative Grid Components

Note that for radial networks that include other grid components besides ZIP loads, the backward pass may differ but the forward pass can remain the same. In particular, equations (7)-(10) may be different.

To account for line charging capacitance/inductance and shunts at any node, the capacitance/inductance can be absorbed into the ZIP load at the corresponding node by the corresponding susceptance (B_{capacitor} or B_{inductor}). The additional reactive power demanded by this component is given by the expression Q_{capacitor}=B_{capacitor}*V² or Q_{inductor}=B_{inductor}*V².

For a generator node, the node power equations can differ. If node-i is a Generator bus (also referred as a PV bus), the power flow equations need to be modified as the generator at this node injects an active power of P_{gen}_{ᵢ} and maintains the node voltage magnitude to V_{gen}_{ᵢ}. Hence, the power flow equations at this node are given below. The equation (12) results from the definition of aggregated active power flow at node i. As P_{gen}_{ᵢ} is positive when a generator injects power into the node, P_{gen}_{ᵢ} needs to be subtracted from the sum of the downstream line flows to get the aggregate power demand as seen by node i, leading to (13).

$${v}_{i} = {v}_{{gen}_{i}} \qquad ( 11 )$$

$$Re ( {{V}_{i} ( \frac{{V}_{p ( i )} - {V}_{i}}{{r}_{i} + {jx}_{i}} )}^{*} ) = {h}_{{P}_{i}} \qquad ( 12 )$$

$${h}_{{p}_{i} =} {\sum }_{k ∈ c ( i )} {f}_{{P}_{k}} - {P}_{{gen}_{i}} \qquad ( 13 )$$

Simplifying (12) to use the phasor representation of node voltages leads to (14) which is simplified to (14)-(18).

$$Re ( {{v}_{i} ( \frac{{v}_{p ( i )} {∠ψ}_{i} - {v}_{i}}{{z}_{i} {∠ϕ}_{i}} )}^{*} ) = {h}_{{P}_{i}} \qquad ( 14 )$$

$$Re ( {v}_{i} ( {v}_{p ( i )} ∠ ( {ϕ}_{i} - {ψ}_{i} ) - {v}_{i} {∠ϕ}_{1} ) ) = {z}_{i} {h}_{{P}_{i}} \qquad ( 15 )$$

$${v}_{i} ( {v}_{p ( i )} cos ( {ϕ}_{i} - {ψ}_{i} ) - {v}_{i} cos ( {ϕ}_{i} ) ) = {z}_{i} {h}_{{P}_{i}} \qquad ( 16 )$$

$$cos ( {ϕ}_{i} - {ψ}_{i} ) = \frac{{z}_{i} {h}_{{P}_{i}}}{{v}_{i} {v}_{p ( i )}} + \frac{{v}_{i} cos ( {ϕ}_{i} )}{{v}_{p ( i )}} \qquad ( 17 )$$

$${ψ}_{i} = {ϕ}_{i} - {cos}^{- 1} ( \frac{{z}_{i} {h}_{{P}_{i}}}{{v}_{i} {v}_{p ( i )}} + \frac{{v}_{i} cos ( {ϕ}_{i} )}{{v}_{p ( i )}} ) \qquad ( 18 )$$

The above equations (11)-(18) remain applicable as long as the reactive power supplied by the generator is within the specified limits (Q_{g,max}, Q_{g,min}). If calculated generator reactive power, Q_{gen} reaches either of these limits, the PV bus will be converted into a load bus, with Q_{gen} fixed at the limiting value. In this scenario, the equations developed for load buses will be applicable

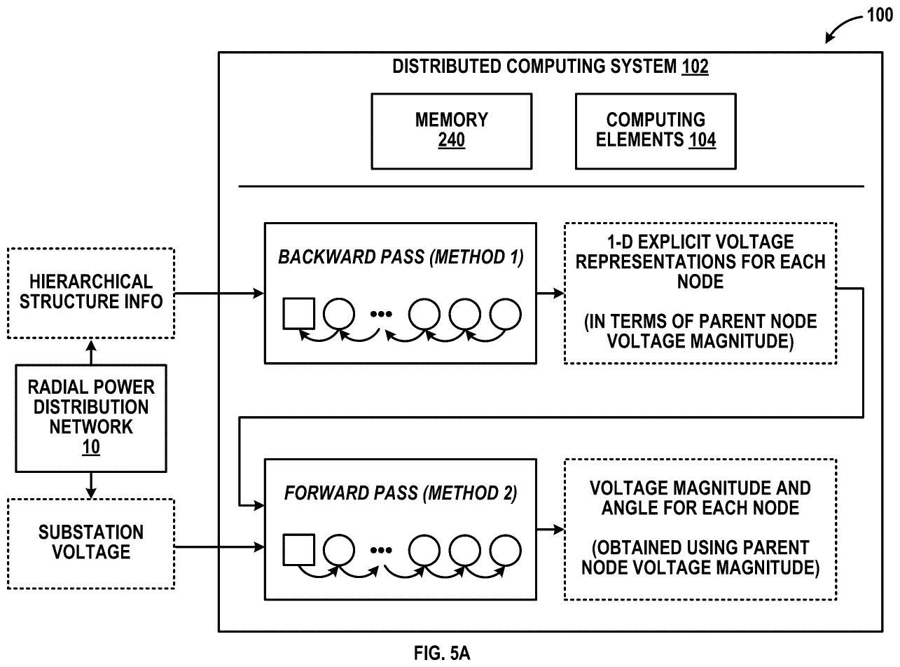

For renewable inverters at a node, the active power (P) at a node is represented as a constant negative load. However, the reactive power (Q) is a piecewise function of the voltage at the node. If node-i is equipped with a renewable inverter, the reactive power injection or absorption at this node will vary according to its voltage level (referred to as a Volt-VAR controller). Accordingly, the reactive power supplied by this inverter will contribute to the overall reactive power injection at the node, facilitating the calculation of h_{Q}_{ᵢ} given in (19). FIG. 4 illustrates the Q injection in relation to the node voltage. When the node Vᵢ falls within the deadband limits (Vₘₐₓ^{db}, Vₘᵢₙ^{db}), the Q injection from the inverter remains at zero. However, if Vᵢ exceeds Vₘₐₓ^{db}, negative VARs will be injected; If Vᵢ is below Vₘᵢₙ^{db}, positive VARs will be injected. The magnitude of the reactive power injected is governed by the slope of the Volt-VAR curve. Additionally, there are defined minimum and maximum limits (Qₘᵢₙ, Qₘₐₓ) for reactive power injection. If the VAR injection reaches either of these thresholds due to variations in node voltage, the injection will be limited to that threshold, irrespective of the node voltage.

$${h}_{{Q}_{i}} = {\sum }_{k ∈ c ( i )} {f}_{{Q}_{k}} + {Q}_{i} + {Q}_{vv} \qquad ( 19 )$$

### IV. Methods for General Radial Systems

In this section, a method is described to efficiently utilize the voltage functions for solving the power flow problem. As the methodology uses the functions as first-order objects, the resulting method is termed as functional power flow.

### A. Overall Method

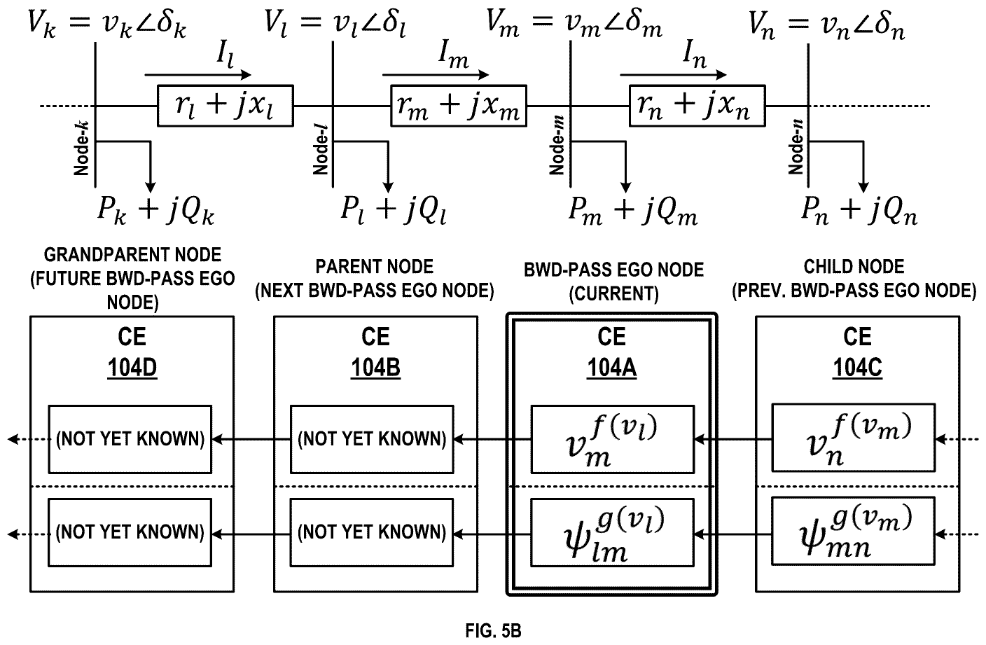

As illustrated in FIG. 5A, the method includes two parts—a backward pass and a forward pass. In the backward pass, the voltage functions are constructed from the radial power system model using the approach described in Section III. In the forward pass, the substation voltage is used to fix the voltage and phase of its children nodes using the voltage functions, and this process cascades through the rest of the grid. This method is similar to the usual iterative backward-forward power flow method but in a higher dimensional functional space. Sometimes, the substation voltage specified may be too low for a solution to exist. In this scenario, conventional iterative methods will diverge after a few iterations. In the current method, this scenario can be identified by the voltage functions, as the parent node voltage will not be in the domain of the voltage function of any of its children nodes. Hence, the forward pass either terminates with a power flow solution or identifies that there is no solution. Methods 1 and 2 present the backward and forward pass steps, respectively.

```
Method 1: Backward pass to sequentially estimate the voltage functions
Data: Radial distribution system model with the nodes and lines numbered appropriately
Result: Equivalent explicit functions vᵢ^{f}^{^{(v}}^{h}^{⁾}, ψₕᵢ^{g}^{^{(v}}^{h}^{⁾} ∀h, l ∈ [symbol]
# h = p(i) and n = Number of nodes
for i = n − 1 : 1 do
  | • get h_{P}_{ᵢ} and h_{Q}_{ᵢ} by adding the node powers and children branch, c(i)
  | powers using (10)
  | • Substitute h_{P}_{ᵢ} and h_{Q}_{ᵢ} into (9) to obtain the functions ƒ(vₚ₍ᵢ₎, vᵢ) = 0 and
  | ψₚ₍ᵢ₎ᵢ = g(vₚ₍ᵢ₎)
  | • Use 1-D interpolation on ƒ(vₚ₍ᵢ₎, vᵢ) = 0 to get vᵢ^{f}^{^{(v}}^{p(i)}^{⁾}
  | • Use 1-D interpolation on ψₚ₍ᵢ₎ᵢ = g(vₚ₍ᵢ₎) to get ψₚ₍ᵢ₎ᵢ^{g}^{^{(v}}^{p(i)}^{⁾}
  | • Save the equivalent explicit functions of node-i
end
```

A key point to note is that the explicit function approximation for deriving vᵢ^{f(v}^{ₚ₍ᵢ₎}⁾ depends on identifying a set of points that lie on the implicit curve f(vₚ₍ᵢ₎, vᵢ). For practical use of the forward pass, it is important for these points to lie on the segment that corresponds to the high-voltage solution of the power flow.

The voltage of the parent node is a free variable while estimating the voltage functions. Singularities are avoided by defining the voltage functions for a high enough parent node voltage to ensure a solution for the downstream network.

```
Method 2: Forward pass to estimate the voltage and angle of the nodes
Data: Equivalent explicit functions vᵢ^{f}^{^{(v}}^{h}^{⁾} and ψₕᵢ^{g}^{^{(v}}^{h}^{⁾} ∀h, l ∈ [symbol]   along with network topology
Result: Voltage vᵢ and angle δᵢ ∀i ∈ [symbol]
Initialize v₀ = v_{sub} and δᵢ = 0 ;
for h = 0 : n − 1 do
  | for i = c(h) do
  | | if vₕ [symbol]   domain (vᵢ^{f}^{^{(v}}^{h}^{⁾}) then
  | | | print ”No solution exists”. Terminate
  | | else
  | | | vᵢ ← vᵢ^{f}^{^{(v}}^{h}^{⁾} ;
  | | | δᵢ ← δₕ + ψₕᵢ^{g}^{^{(v}}^{h}^{⁾} ;
  | | end
  | end
end
```

### B. Advantages and Features of Functional Power Flow

The first key feature and advantage of the method is its non-iterative nature. There is no need to initialize the process with an estimate of the node voltages. Furthermore, only a single backward and forward pass is necessary for radial systems with general ZIP loads. Most methods cannot guarantee the number of iterations to reach the solution, especially with ZIP loads. An additional advantage is the matrix-free and distributed nature of the approach with computing elements only communicating the 1-D functions from children nodes to their parent nodes. Thus, the approach has the simplicity of the BFS method with the accuracy of a Newton-based method.

### D. Computer-Implemented System

Referring to FIGS. 5A-5C, a system 100 outlined herein evaluates voltage magnitude and angle for each respective node of a radial power distribution network 10. In a backward pass, the system 100 implements Method 1 to construct 1-D explicit voltage representations for each node that are in terms of voltages of their parent node, such that when the backward pass is complete, the 1-D explicit voltage representations can be used to obtain voltage magnitudes and angles for each node at the forward pass. By setting up the 1-D explicit voltage representations in the backward pass to each be dependent upon voltage magnitudes of the parent node, the system 100 only needs the voltage magnitude of the substation bus to obtain voltage magnitudes and angles for each subsequent node in the forward pass (i.e., by using the substation voltage to obtain voltage magnitude and angle for a first node which is a child node of the substation bus, then using the voltage magnitude for the first node to obtain voltage magnitude and angle for a second node which is a child node of the first node, and so forth).

The system 100 and associated methods outlined herein can be implemented using a distributed computing system 102 which can include a plurality of computing elements 104. As mentioned above, during the backward pass, each computing element 104 may only need to communicate the 1-D explicit voltage representation for a given node to another computing element 104 that is associated with a parent node.

The following discussion pertaining to FIGS. 5B and 5C uses a term “ego node” to indicate a node of the radial power distribution network 10 that is the present focus of computation by a computing element 104. In addition, FIGS. 5B and 5C show nodes labeled with k, l, m, and n.

### Backward Pass

In FIG. 5B illustrating a “snapshot” of the backward pass, a first computing element 104A of the plurality of computing elements accesses information about a hierarchical structure of the radial power distribution network 10 including information about a backward-pass ego node (Node-m) of the radial power distribution network 10 and one or more child nodes (Node-n) of the backward-pass ego node (Node-m).

The first computing element 104A constructs, based on the one or more child nodes (i.e., Node-n) of the backward-pass ego node (Node-m), a one-dimensional explicit voltage representation vₘ^{f(v}^{ₗ}⁾ for the backward-pass ego node (Node-m) that represents a bus voltage magnitude vₘ of the backward-pass ego node in terms of a bus voltage magnitude vₗ of a parent node (Node-l) of the backward-pass ego node (Node-m). The first computing element 104A (or a different computing element) can also construct, based on the one or more child nodes (i.e., Node-n) of the backward-pass ego node (Node-m), a one-dimensional explicit angle representation ψₗₘ^{g(v}^{ₗ}⁾ for the backward-pass ego node (Node-m) that represents a bus voltage angle difference δₘ between the backward-pass ego node (Node-m) and the parent node (Node-l) in terms of the bus voltage magnitude vₗ of the parent node (Node-l).

The first computing element 104A can then communicate the one-dimensional explicit voltage representation vₘ^{f(v}^{ₗ}⁾ for the backward-pass ego node (Node-m) from the first computing element 104A to a second computing element 104B of the plurality of computing elements of the distributed computing system 102, and can likewise communicate the one-dimensional explicit angle representation ψₗₘ^{g(v}^{ₗ}⁾ for the backward-pass ego node (Node-m) to the second computing element 104B.

### Backward Pass: Incorporating Child Nodes

Note that the one-dimensional explicit voltage representation vₘ^{f(v}^{ₗ}⁾ and the one-dimensional explicit angle representation ψₗₘ^{g(v}^{ₗ}⁾ for the backward-pass ego node (Node-m) can each incorporate a representation of aggregated active power (h_{P}_{ᵢ}, where i=m and j=n) and a representation of aggregated reactive power (h_{Q}_{ᵢ} where i=m and j=n) of the radial power distribution network (see Eq. (10)) as observed by the backward-pass ego node (Node-m), including a sum of power flows on one or more power lines from the backward-pass ego node (Node-m) to the one or more child nodes (Node-n). As such, prior to determining the one-dimensional explicit voltage representation vₘ^{f(v}^{ₗ}⁾ and/or the one-dimensional explicit angle representation ψₗₘ^{g(v}^{ₗ}⁾ for the backward-pass ego node (Node-m), the first computing element 104A can access, from a third computing element 104C of the plurality of computing elements, a one-dimensional explicit voltage representation vₙ^{f(v}^{ₘ}⁾ for the child node (Node-n) of the backward-pass ego node (Node-m), the one-dimensional explicit voltage representation vₙ^{f(v}^{ₘ}⁾ for the child node (Node-n) being in terms of a bus voltage magnitude ψvₘ of the backward-pass ego node (Node-m). The first computing element 104A can determine a representation of aggregated active power (h_{P}_{ᵢ}, where i=m and j=n) and a representation of aggregated reactive power (h_{Q}_{ᵢ} where i=m and j=n) of the radial power distribution network 10 as observed by the backward-pass ego node (Node-m) based on the one-dimensional explicit voltage representation vₙ^{f(v}^{ₘ}⁾ for the child node (Node-n). If the backward-pass ego node has multiple child nodes (not counting “grandchildren” nodes), then contributions from each child node are summed as discussed herein with respect to Eq. (3). If the backward-pass ego node does not have any child nodes (e.g., is a leaf node), then aggregated active power and aggregated reactive power are simply the active and reactive powers associated with the backward-pass ego node alone.

### Backward Pass: Parent Node

The second computing element 104B can access information about the hierarchical structure of the radial power distribution network 10 including: information about the parent node (Node-l) of the backward-pass ego node (Node-m) and information about one or more child nodes of the parent node, the one or more child nodes of the parent node including the backward-pass ego node (Node-m) associated with the first computing element 104A; and the one-dimensional explicit voltage representation vₘ^{f(v}^{ₗ}⁾ for the backward-pass ego node (i.e., child node Node-m) associated with the first computing element 104A. The second computing element 104B can construct, based on the one or more child nodes of the parent node (Node-l), a one-dimensional explicit voltage representation vₗ^{f(v}^{ₖ}⁾ for the parent node (Node-l) that represents a bus voltage magnitude vₗ of the parent node (Node-l) in terms of a bus voltage magnitude vₖ of a grandparent node (Node-k) of the backward-pass ego node (Node-m) associated with the first computing element 104A. Likewise, the second computing element 104B (or another computing element of the plurality of computing elements) can construct, based on the one or more child nodes of the parent node (Node-l) of the backward-pass ego node (Node-m), a one-dimensional explicit angle representation ψₖₗ^{g(v}^{ₖ}⁾ for the parent node (Node-l) that represents a bus voltage angle δₗ of the parent node in terms of a bus voltage magnitude vₖ of the grandparent node (Node-k) of the backward-pass ego node (Node-m) associated with the first computing element 104A. The second computing element 104B can then communicate the one-dimensional explicit voltage representation vₗ^{f(v}^{ₖ}⁾ for the parent node (Node-l) from the second computing element 104B to a fourth computing element 104D of the plurality of computing elements of the distributed computing system 102, and can likewise communicate the one-dimensional explicit angle representation ψₖₗ^{g(v}^{ₖ}⁾ for the parent node (Node-l) to the fourth computing element 104D.

### Backward-Pass Ego Node, Node Hierarchy, and Backward Pass Sequence

While the previous paragraph is written in terms of the backward-pass ego node being Node-m (to illustrate the relationship Node-m and its parent node Node-l and its grandparent node Node-k), the second computing element 104B considers the parent node (Node-l) as its backward-pass ego node and can incorporate the one-dimensional explicit voltage representation vₘ^{f(v}^{ₗ}⁾ for its child node (i.e., Node-m), which had previously been provided to the second computing element 104B from the first computing element 104A. This concept is illustrated in FIG. 5B where the “current” focus is on Node-m as the backward-pass ego node from the perspective of the first computing element 104A. Node-n is a child node of Node-m and was the previous backward-pass ego node which had previously been the focus of computation by the third computing element 104C. Continuing the pattern, Node-l is a parent node of Node-m and is the next backward-pass ego node considered as the focus of computation by the second computing element 104B. Likewise, Node-k is the parent node of Node-l (and the grandparent node of Node-m) and is a future backward-pass ego node considered as the focus of computation by the fourth computing element 104D and so forth.

During the backward pass, this process continues sequentially starting with a leaf node (i.e., a childless node) until the substation node is reached. A computing element can obtain, for a Node-1 whose parent node is the substation node (Node-0), a one-dimensional explicit voltage representation v₁^{f(v}^{₀}⁾ and a one-dimensional explicit angle representation ψ_{1,0}^{g(v}^{₀}⁾ which are in terms of the bus voltage magnitude v₀ of the substation node. This results in all the voltage magnitude and angle representations for the radial power distribution network 10 being essentially dependent on the bus voltage magnitude v₀ of the substation node, because each voltage magnitude and angle representation for each node connects back to a parent node which eventually connects back to the substation node. In this manner, the “backward pass” can be employed to significantly reduce computational complexity and communication between individual computing elements by eliminating unknown variables within the radial power distribution network 10 and instead constructing explicit representations for voltage magnitude and angle for each node in terms of a single factor, i.e., the voltage magnitude of the parent node.

As such, as a whole, the distributed computing system 102 can sequentially construct, starting with a leaf node of the radial power distribution network 10 as a backward-pass ego node (Node-i) and propagating in a backward direction towards a substation bus of the radial power distribution network 10, each respective computing element of the plurality of computing elements constructing for a respective node of the radial power distribution network 10: a one-dimensional explicit voltage representation vᵢ^{f(v)v}^{ₚ₍ᵢ₎} that represents a bus voltage magnitude of the backward-pass ego node (Node-i) in terms of a bus voltage magnitude vₚ₍ᵢ₎ of a parent node (Node-p(i)) of the backward-pass ego node (Node-i); and a one-dimensional explicit angle representation ψₚ₍ᵢ₎ᵢ^{g(v}^{ₚ₍ᵢ₎}⁾ that represents a bus voltage angle difference δᵢ between the backward-pass ego node (Node-i) and the parent node (Node-p(i)) in terms of the bus voltage magnitude vₚ₍ᵢ₎ of the parent node (Node-p(i)). Each computing element need only communicate the one-dimensional explicit voltage and/or angle representation for its backward pass ego node to the next computing element that is focusing on the parent node of the backward pass ego node, and need only focus on incorporating representations from previous computing elements that corresponds to direct child nodes of the backward pass ego node, which reduces computational complexity for each computing element and reduces the amount and type of information that needs to be passed between computing elements.

As discussed, to incorporate powers associated with other distributed energy resources such as generator nodes and renewable inverters, power flow equations can be augmented as in equations (11)-(19) as outlined herein.

### Forward Pass

Following the backward pass, FIG. 5C shows an example “snapshot” of the forward pass where each computing element solves for bus voltage magnitude and angle difference for a forward pass ego node based on a known voltage magnitude of a parent node of the forward pass ego node.

In FIG. 5C, nodes k, l, m and n are shown again with Node-m being the forward pass ego node for first computing element 104A. First computing element 104A accesses an evaluated bus voltage magnitude vₗ for a parent node (Node-l) of the forward pass ego node (Node-m), and evaluates the bus voltage magnitude vₘ for the forward pass ego node (Node-m) based on substitution of the evaluated bus voltage magnitude vₗ of the parent node (Node-l) of the forward pass ego node (Node-m) into a one-dimensional explicit voltage representation vₘ^{f(v}^{ₗ}⁾ for the forward-pass ego node (Node-m) (which correlates with the one-dimensional explicit voltage representation vₘ^{f(v}^{ₗ}⁾ for Node-m obtained during the backward pass in which Node-m was the backward-pass ego node for first computing element 104A). Similarly, first computing element 104A (or another computing element) evaluates a bus voltage angle difference δₘ of the forward-pass ego node (Node-m) based on substitution of the evaluated bus voltage magnitude vₗ of the parent node (Node-l) of the forward pass ego node (Node-m) into a one-dimensional explicit angle representation ψₗₘ^{g(v}^{ₗ}⁾ for the forward-pass ego node (Node-m) (which correlates with the one-dimensional explicit angle representation ψₗₘ^{g(v}^{ₗ}⁾ for Node-m obtained during the backward pass in which Node-m was the backward-pass ego node for first computing element 104A or another computing element).

### Forward Pass: Parent Nodes

Prior to evaluating voltage magnitude and angle for (current) forward-pass ego node (Node-m), the fourth computing element 104D focusing on Node-k as a past forward-pass ego node determines an evaluated bus voltage magnitude vₖ for Node-k, which is the grandparent node of (current) forward-pass ego node (Node-m) based on an evaluated bus voltage of a great-grandparent node of (current) forward-pass ego node (Node-m), and communicates the evaluated bus voltage magnitude vₖ to the second computing element 104B which focuses on Node-l as a previous forward-pass ego node. Subsequently, the second computing element 104B focusing on Node-l as a previous forward-pass ego node determines the evaluated bus voltage magnitude vₗ for Node-l based on the evaluated bus voltage magnitude vₖ for Node-k, and communicates the evaluated bus voltage magnitude vₗ to the first computing element 104A.

### Forward Pass: Child Nodes

Upon determining the evaluated bus voltage magnitude vₘ for the forward pass ego node (Node-m), the first computing element 104A can communicate the evaluated bus voltage magnitude vₘ to the second computing element 104C which will evaluate the bus voltage magnitude vₙ for the next forward pass ego node (Node-n, which is a child node of Node-m) based on substitution of the evaluated bus voltage magnitude vₙ of the parent node (i.e., Node-m) of the next forward pass ego node (Node-n) into a one-dimensional explicit voltage representation vₙ^{f(v}^{ₘ}⁾ for the next forward-pass ego node (Node-n). Likewise, the second computing element 104C (or another computing element) evaluates a bus voltage angle difference δₙ of the next forward-pass ego node (Node-n) based on substitution of the evaluated bus voltage magnitude vₘ of the parent node (i.e., Node-m) of the next forward pass ego node (Node-n) into a one-dimensional explicit angle representation ψₘₙ^{g(m)} for the next forward-pass ego node (Node-m).

During the forward pass, this process continues sequentially starting with the substation node until the leaf node is reached. A computing element can obtain, for a Node-1 whose parent node is the substation node (Node-0), an evaluated bus voltage magnitude v₁ and an evaluated bus angle difference δ₁ based on substitution of the bus voltage magnitude v₀ of the substation node into the one-dimensional explicit voltage representation v₁^{f(v}^{₀}⁾ and the one-dimensional explicit angle representation ψ_{1,0}^{g(v}^{₀}⁾ which are in terms of the bus voltage magnitude v₀ of the substation node. Subsequently, computing elements can obtain evaluated bus voltage magnitude and evaluated bus angle difference for subsequent nodes based on bus voltage magnitude of parent nodes in a cascading manner, due to the nested nature of the one-dimensional explicit voltage magnitude and angle representations obtained during the backward pass. This results in the ability to evaluate all the voltage magnitudes and angles for the radial power distribution network 10 with knowledge of the bus voltage magnitude v₀ of the substation node, because each voltage magnitude and angle representation for each node connects back to a parent node which eventually connects back to the substation node. In this manner, the “forward pass” can be employed to significantly reduce computational complexity and communication between individual computing elements by eliminating unknown variables within the radial power distribution network 10 and the need for an initial guess, and instead enabling evaluation of voltage magnitudes and angles for each node in a cascading manner based on the voltage magnitude of the parent node.

As such, as a whole, the distributed computing system 102 can sequentially evaluate, starting with a child node of a substation bus of the radial power distribution network as a forward-pass ego node (Node-i) and propagating in a forward direction towards a leaf node of the radial power distribution network 10: a bus voltage magnitude vᵢ of the forward-pass ego node (Node-i) based on substitution of an evaluated bus voltage magnitude vₚ₍ᵢ₎ of a parent node (Node-p(i)) of the forward-pass ego node (Node-i) into a one-dimensional explicit voltage representation vᵢ^{f(v)v}^{ₚ₍ᵢ₎} for the forward-pass ego node (Node-i); and a bus voltage angle difference δᵢ of the forward-pass ego node (Node-i) based on substitution of the evaluated bus voltage magnitude vₚ₍ᵢ₎ of the parent node (Node-p(i)) into a one-dimensional explicit angle representation ψₚ₍ᵢ₎ᵢ^{g(v}^{ₚ₍ᵢ₎}⁾ for the forward-pass ego node (Node-p(i)).

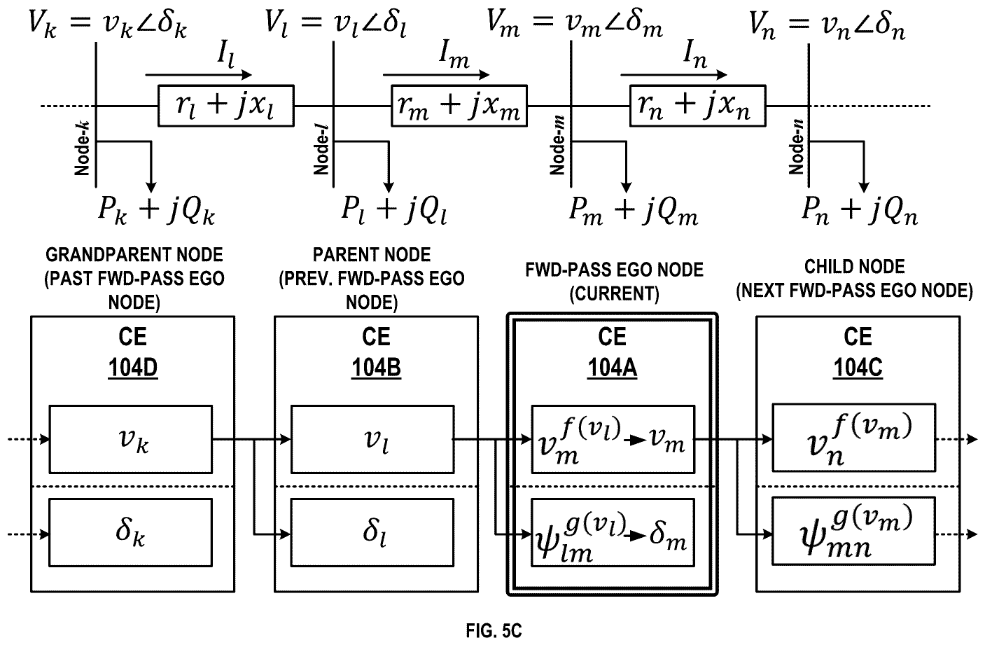

FIG. 6 is a schematic block diagram of an example device 200 that may be used with one or more embodiments described herein, e.g., as a component of distributed computing system 102 of system 100 shown in FIGS. 5A-5C and implementing the methods and processes outlined herein. Device 200 can be a computing device that includes or otherwise communicates with the plurality of computing elements of the distributed computing system 102 (e.g., first computing element 104A, second computing element 104B, third computing element 104C, fourth computing element 104D), where the plurality of computing elements can include one or more Graphics Processing Units (GPUs), one or more Central Processing Units (CPUs), one or more Application-Specific Integrated Circuits (ASICs), and/or one or more Field Programmable Gate Arrays (FPGAs).

Device 200 comprises one or more network interfaces 210 (e.g., wired, wireless, PLC, etc.), at least one processor 220 (which can include one or more GPUs, CPUs, ASICs, and/or FPGAs), and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include non-transitory computer readable media. Memory 240 can include instructions executable by the processor 220 that, when executed by the processor 220, cause the processor 220 to implement aspects of the system 100 and the methods outlined herein.

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include Power Flow Evaluation processes/services 290, which can include aspects of Methods 1 and 2 and/or implementations of various modules described herein such as those described with respect to FIGS. 1-5C. Note that while Power Flow Evaluation processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the Power Flow Evaluation processes/services 290 is shown as a standalone process, those skilled in the art will appreciate that this process may be executed as a routine or module within other processes.

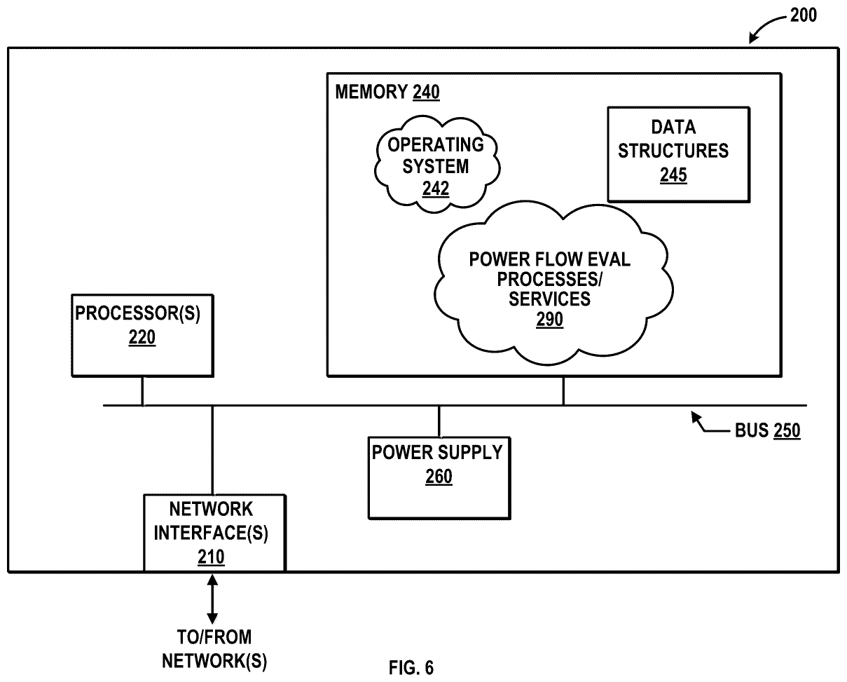

FIG. 7A is a first process flow diagram showing a first process 300 that can be implemented at a computing element to construct 1-D explicit voltage magnitude and angle representations for a backward-pass ego node. Step 302 of first process 300 can include accessing information about a backward-pass ego node. Step 304 of first process 300 can include accessing a 1-D explicit voltage magnitude representation for a child node of the backward-pass ego node from a computing element associated with the child node. Step 306 of first process 300 can include determining a representation of aggregated active power and a representation of aggregated reactive power as observed by the backward-pass ego node. Step 308 of first process 300 can include constructing a 1-D explicit voltage magnitude representation for the backward-pass ego node that represents bus voltage magnitude of the backward-pass ego node in terms of a bus voltage magnitude of the parent node. Step 310 of first process 300 can include constructing a 1-D explicit voltage angle representation for the backward-pass ego node that represents bus voltage angle difference of the backward-pass ego node in terms of a bus voltage magnitude of the parent node. Step 312 of first process 300 can include communicating the 1-D explicit voltage angle representation for the backward-pass ego node to a computing element associated with the parent node.

FIG. 7B is a second process flow diagram showing a second process 400 that can be implemented at a computing element to evaluate voltage magnitude and angle for a forward-pass ego node. Step 402 of second process 400 includes accessing an evaluated bus voltage magnitude for a parent node from a computing element associated with the parent node. Step 404 of second process 400 includes substituting the evaluated bus voltage magnitude for the parent node into a 1-D explicit voltage magnitude representation for the forward-pass ego node to obtain an evaluated bus voltage magnitude for the forward-pass ego node. Step 406 of second process 400 includes substituting the evaluated bus voltage magnitude for the parent node into a 1-D explicit voltage angle representation for the forward-pass ego node to obtain an evaluated bus voltage angle difference for the forward-pass ego node. Step 408 of second process 400 includes communicating the evaluated bus voltage for the forward-pass ego node to a computing element associated with the child node.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

The 1-D explicit voltage magnitude/angle representations and the evaluated bus voltage magnitude and angles of the nodes of the radial power distribution network 10 can be used for design, optimization, modeling, and monitoring of the radial power distribution network 10. In some examples, evaluated bus voltage magnitude and angles can be obtained for an input space of voltages associated with the substation node. The evaluated bus voltage magnitude and angles can be compared with actual bus voltage magnitude and angles for error monitoring and diagnosis, e.g., to identify faulty elements of the radial power distribution network 10.

### V. Numerical Results

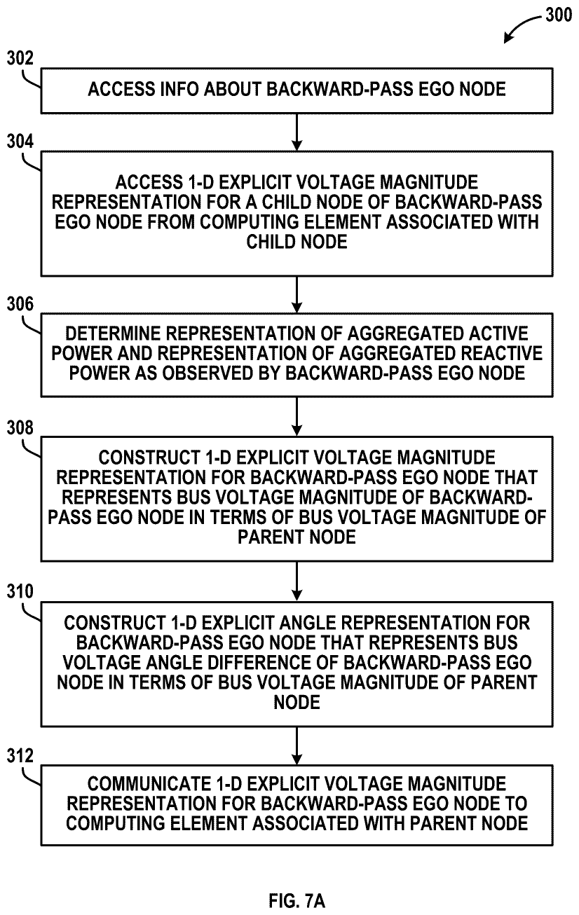

The method is implemented in MATLAB on a 8 GB workstation with an Intel 15 processor, and MATPOWER is used as a benchmark for comparison. Detailed numerical results on a 5-bus system in FIG. 8 are presented, followed by a brief discussion of the results on larger MATPOWER test systems. The overlapping partitions (ovals) in FIG. 8 illustrate the distributed data exchange necessary to estimate the voltage functions. Bus 2 only uses information from buses 3 and 4 while bus 1 only uses data from bus 2.

### A. 5-Bus System with ZIP Loads

In the first scenario, nodes 1, 2 and 3 have a nominal load power of 0.2+j0.1 p. u. while node 4 has a nominal load power of 0.4+j0.2 p. u. The impedance of all the lines in the 5-bus system is equal to 0.1+j0.1 p. u. The substation voltage is equal to 1.1 p. u. Three different cases of ZIP parameters (μ_{Z}, μ_{I}, μ_{P}) are considered: case-1: [0.1, 0.1, 0.8], case-2: [0.1, 0.8, 0.1] and case-3: [0.8, 0.1, 0.1]. It can be seen that case-1 is dominated by the constant power load while case-2 is dominated by the current load and case-3 is dominated by the impedance load. Table I lists the voltage magnitudes from the functional power flow and the error in comparison to the MATPOWER solution. It can be seen that the errors are minimal for all cases, illustrating the accuracy of the method.

TABLE I
VOLTAGE MAGNITUDES RESULTING FROM THE
FUNCTIONAL POWER FLOW METHOD AND THE ERROR
COMPARED TO MATPOWER FOR PQ CASE

| | Case 1 | | Case 2 | | Case 3 | |
|---|---|---|---|---|---|---|
| | vᵢ | Error | vᵢ | Error | vᵢ | Error |
| Bus 0 | 1.1000 | 0 | 1.1000 | 0 | 1.1000 | 0 |
| Bus 1 | 0.9028 | −2.17E−4 | 0.9464 | −4.52E−4 | 0.9629 | −4.3E−4 |
| Bus 2 | 0.7402 | −3.20E−4 | 0.8243 | −7.67E−4 | 0.8562 | −5.5E−4 |
| Bus 3 | 0.7007 | −3.43E−4 | 0.7941 | −7.76E−4 | 0.8296 | −5.8E−4 |
| Bus 4 | 0.6566 | −3.76E−4 | 0.7636 | −8.62E−4 | 0.8040 | −5.4E−4 |

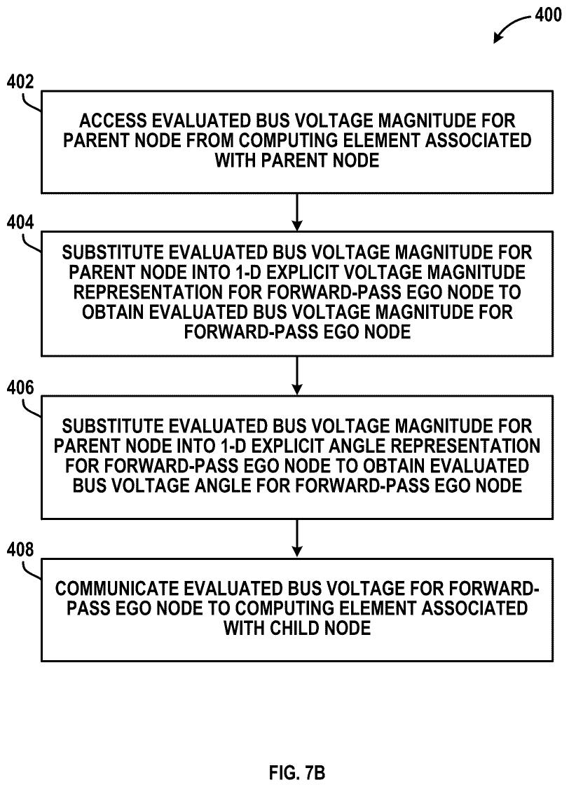

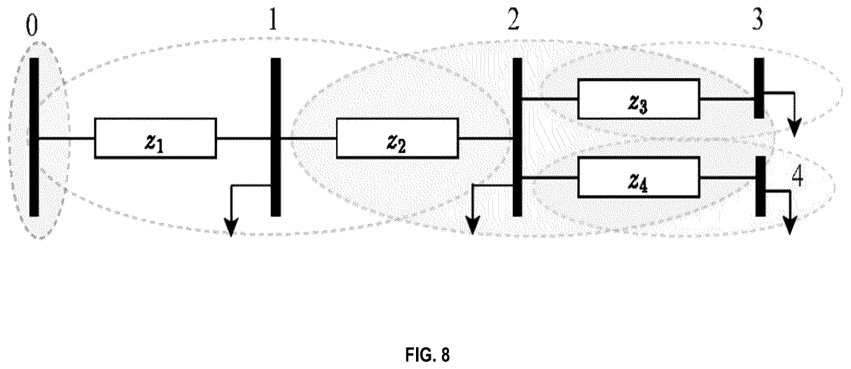

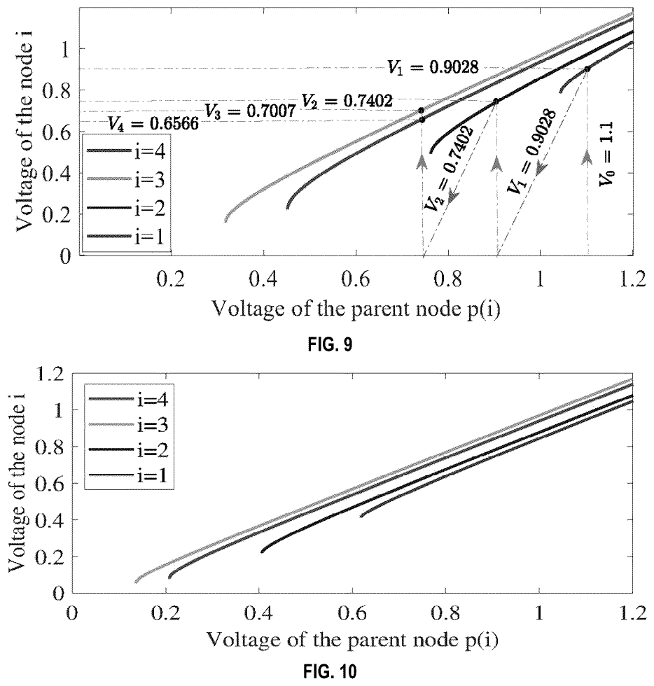

FIGS. 9, 10, and 11 plot the voltage functions vᵢ^{f(v}^{ₚ₍ᵢ₎}⁾ for the three ZIP cases that were estimated using Method-1 in Section IV. The procedure to sequentially obtain the individual bus voltages from the voltage functions for case 1 with a substation voltage, V₀=1.1 p. u., is also illustrated pictorially in FIG. 9. From FIG. 8, it is evident that the parent node for node-1 is the substation node. Therefore, node-1 voltage is obtained, for a V₀=1.1 p. u., as V₁=0.9028 p. u. from the node-1 voltage function. Node-1 is the parent node for node-2, as shown in FIG. 8. Therefore, V₂ can be obtained from the node-2 voltage function at a parent node voltage of V₁=0.9028p. u. leading to V₂=0.7402p. u. The parent node for nodes 3 and 4 is the same, i.e., node-2. From the respective voltage functions, V₃ and V₄ can be determined at a parent node voltage, V₂=0.7402 p. u. The obtained voltages are V₃=0.7007p. u and V₄=0.6566p. u.

Another observation from FIGS. 9, 10, and 11 is that the voltage functions have a parent voltage threshold below which the function vᵢ^{f(v}^{ₚ₍ᵢ₎}⁾ does not exist due to the lack of a real solution of 9. On comparing the curves between the three cases for the same node, it can be observed that the threshold voltages are lowest for the impedance dominated case and are highest for the constant power dominated case. This is expected as impedance loads reduce system stress. Constant current loads have a similar behavior but are less pronounced than the impedance loads. Hence, the voltage functions provide insight into the system stress, which is an added benefit of the proposed method.

### B. Summary of Results on MATPOWER Test Cases

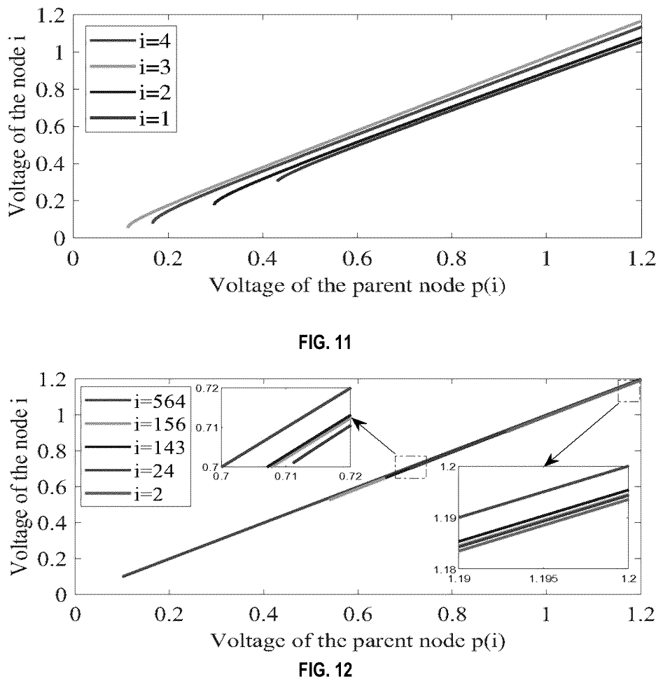

The functional power flow has been evaluated with ZIP parameters: [0.2, 0.2, 0.6] on various radial test cases within MATPOWER, as well as on two newly generated large radial distribution systems. These new test cases, named case423 and case564, are constructed by connecting multiple instances of the MATPOWER 141-bus system in series. To appropriately scale these systems, both bus loads and branch impedances are adjusted accordingly. For the 564-bus system, these values are reduced to half of their original values. Plots of the voltage function obtained for select buses in the 564-bus distribution test system are depicted in FIG. 12. The results, including the maximum voltage error compared to the MATPOWER solution, the maximum power mismatch, and the computation time for both MATPOWER and functional power flow, are presented in Table II. Thus, the proposed method not only demonstrates accuracy but also achieves faster computation speeds, comparable to MATPOWER, through the utilization of voltage functions.

TABLE II
THE MAXIMUM ERROR IN Vᵢ COMPARED
TO MATPOWER AND POWER MISMATCH USING
THE FUNCTIONAL POWER FLOW(FPF)

| Case | Max. V | Max. Power | MATPOWER | FPF |
|---|---|---|---|---|
| Name | error(p.u.) | Mismatch(p.u.) | time(ms) | Time(ms) |
| case33bw | 7.2 × 10⁻⁶ | 1.3 × 10⁻⁶ | 52 | 1.2 |
| case69 | 5.2 × 10⁻⁶ | 3.0 × 10⁻⁶ | 55 | 2.3 |
| case85 | 1.1 × 10⁻⁵ | 8.9 × 10⁻⁶ | 57 | 2.8 |
| case141 | 5.5 × 10⁻⁶ | 1.3 × 10⁻⁶ | 60 | 4.2 |
| case423 | 5.9 × 10⁻⁶ | 8.5 × 10⁻⁷ | 76 | 13 |
| case564 | 5.4 × 10⁻⁵ | 7.8 × 10⁻⁷ | 81 | 16 |

### VI. Conclusions

The present disclosure outlines a non-iterative matrix-free power flow solver that can solve the power flow problem on radial networks with ZIP loads without the need for an initial guess. This is achieved by converting the implicit equations that arise in the power flow equations into the appropriate explicit functions by sequentially eliminating voltages in the grid. Interpolation methods are used to efficiently estimate these functions in a computationally tractable manner while limiting the voltage functions to be 1-D. The method is tested on several test cases in MATPOWER and the results validate the accuracy and robustness of the method.

The functional power flow aims for efficient execution on modern computing devices optimized for distributed computation. The results outlined in this disclosure validates correctness of the method by comparing to MATPOWER results. is the systems and methods outlined herein can be implemented using Field Programmable Gate Arrays (FPGAs) and Graphics Processing Units (GPUs) and can be adjusted for speedup and scalability in distributed computing architectures. A rigorous proof of the method will enable generalization for generators and DERs. Establishing links between voltage functions and system stability criteria will enhance the methodology's utility for a wider audience.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a distributed computing system including a memory and a plurality of computing elements, the memory including instructions executable by the plurality of computing elements to:
access, at a first computing element of the plurality of computing elements, information about a hierarchical structure of a radial power distribution network including information about a backward-pass ego node of the radial power distribution network and one or more child nodes of the backward-pass ego node;
construct, at the first computing element and based on the one or more child nodes of the backward-pass ego node, a one-dimensional explicit voltage representation for the backward-pass ego node that represents a bus voltage magnitude of the backward-pass ego node in terms of a bus voltage magnitude of a parent node of the backward-pass ego node; and
communicate the one-dimensional explicit voltage representation for the backward-pass ego node from the first computing element to a second computing element of the plurality of computing elements of the distributed computing system.

2. The system of claim 1, the one-dimensional explicit voltage representation for the backward-pass ego node incorporating a representation of aggregated active power and a representation of aggregated reactive power of the radial power distribution network as observed by the backward-pass ego node, including a sum of power flows on one or more power lines from the backward-pass ego node to the one or more child nodes.

3. The system of claim 1, the memory including instructions executable by the plurality of computing elements to:
access, at the second computing element of the plurality of computing elements, information about a hierarchical structure of a radial power distribution network including:
information about the parent node of the backward-pass ego node of the radial power distribution network and information about one or more child nodes of the parent node, the one or more child nodes of the parent node including the backward-pass ego node; and
the one-dimensional explicit voltage representation for the backward-pass ego node from the first computing element;
and
construct, at the second computing element and based on the one or more child nodes of the parent node, a one-dimensional explicit voltage representation for the parent node that represents a bus voltage magnitude of the parent node in terms of a bus voltage magnitude of a grandparent node of the backward-pass ego node.

4. The system of claim 1, the memory including instructions executable by the plurality of computing elements to:
construct, based on the one or more child nodes of the backward-pass ego node, a one-dimensional explicit angle representation for the backward-pass ego node that represents a bus voltage angle difference between the backward-pass ego node and the parent node in terms of the bus voltage magnitude of the parent node; and
communicate the one-dimensional explicit angle representation for the backward-pass ego node to the second computing element of the distributed computing system.

5. The system of claim 4, the one-dimensional explicit angle representation for the backward-pass ego node incorporating a representation of aggregated active power and a representation of aggregated reactive power of the radial power distribution network as observed by the backward-pass ego node, including a sum of power flows on one or more power lines from the backward-pass ego node to the one or more child nodes.

6. The system of claim 4, the memory including instructions executable by the plurality of computing elements to:
access, at the second computing element of the plurality of computing elements, information about a hierarchical structure of a radial power distribution network including:
information about the parent node of the backward-pass ego node of the radial power distribution network and information about one or more child nodes of the parent node, the one or more child nodes of the parent node including the backward-pass ego node; and
the one-dimensional explicit angle representation for the backward-pass ego node from the first computing element;
and
construct, at the second computing element and based on the one or more child nodes of the parent node, a one-dimensional explicit angle representation for the parent node that represents a bus voltage angle of the parent node in terms of a bus voltage magnitude of a grandparent node of the backward-pass ego node.

7. The system of claim 1, the memory including instructions executable by the plurality of computing elements to:
access, at the first computing element and from a third computing element of the plurality of computing elements, a one-dimensional explicit voltage representation for a child node of the one or more child nodes of the backward-pass ego node, the one-dimensional explicit voltage representation for the child node being in terms of a bus voltage magnitude of the backward-pass ego node; and
determine, at the first computing element, a representation of aggregated active power and a representation of aggregated reactive power of the radial power distribution network as observed by the backward-pass ego node based on the one-dimensional explicit voltage representation for the child node.

8. The system of claim 1, the memory including instructions executable by the plurality of computing elements to:
access, at the first computing element of the distributed computing system and from a third computing element of the plurality of computing elements, a one-dimensional explicit angle representation for a child node of the one or more child nodes of the backward-pass ego node, the one-dimensional explicit angle representation for the child node being in terms of a bus voltage magnitude of the backward-pass ego node; and
determine a representation of aggregated active power and a representation of aggregated reactive power of the radial power distribution network as observed by the backward-pass ego node based on the one-dimensional explicit voltage representation for the child node.

9. The system of claim 1, the memory including instructions executable by the plurality of computing elements to:
sequentially construct, starting with a leaf node of the radial power distribution network as a backward-pass ego node and propagating in a backward direction towards a substation bus of the radial power distribution network, each respective computing element of the plurality of computing elements constructing for a respective node of the radial power distribution network:
a one-dimensional explicit voltage representation that represents a bus voltage magnitude of the backward-pass ego node in terms of a bus voltage magnitude of a parent node of the backward-pass ego node; and
a one-dimensional explicit angle representation that represents a bus voltage angle difference between the backward-pass ego node and the parent node in terms of the bus voltage magnitude of the parent node.

10. The system of claim 1, the memory including instructions executable by the plurality of computing elements to:
sequentially evaluate, starting with a child node of a substation bus of the radial power distribution network as a forward-pass ego node and propagating in a forward direction towards a leaf node of the radial power distribution network:
a bus voltage magnitude of the forward-pass ego node based on substitution of an evaluated bus voltage magnitude of a parent node of the forward-pass ego node into a one-dimensional explicit voltage representation for the forward-pass ego node; and
a bus voltage angle difference of the forward-pass ego node based on substitution of the evaluated bus voltage magnitude of the parent node into a one-dimensional explicit angle representation for the forward-pass ego node.

11. A system, comprising:
a distributed computing system including a memory and a plurality of computing elements, the memory including instructions executable by the plurality of computing elements to:
access information about a hierarchical structure of a radial power distribution network;
sequentially construct, starting with a leaf node of the radial power distribution network as a backward-pass ego node and propagating in a backward direction towards a substation bus of the radial power distribution network:
a one-dimensional explicit voltage representation that represents a bus voltage magnitude of the backward-pass ego node in terms of a bus voltage magnitude of a parent node of the backward-pass ego node; and
a one-dimensional explicit angle representation that represents a bus voltage angle difference between the backward-pass ego node and the parent node in terms of the bus voltage magnitude of the parent node; and
sequentially evaluate, starting with a child node of the substation bus of the radial power distribution network as a forward-pass ego node and propagating in a forward direction towards the leaf node of the radial power distribution network:
a bus voltage magnitude of the forward-pass ego node based on substitution of an evaluated bus voltage magnitude of the parent node into the one-dimensional explicit voltage representation for the forward-pass ego node; and
a bus voltage angle of the forward-pass ego node based on substitution of the evaluated bus voltage magnitude of the parent node into the one-dimensional explicit angle representation for the forward-pass ego node.

12. The system of claim 11, the plurality of computing elements including a first computing element and the memory including instructions executable by the first computing element to:
access information about a hierarchical structure of a radial power distribution network including information about the backward-pass ego node of the radial power distribution network and one or more child nodes of the backward-pass ego node;
construct, at the first computing element and based on the one or more child nodes of the backward-pass ego node, a one-dimensional explicit voltage representation for the backward-pass ego node that represents a bus voltage magnitude of the backward-pass ego node in terms of a bus voltage magnitude of a parent node of the backward-pass ego node, the one-dimensional explicit voltage representation for the backward-pass ego node incorporating a representation of aggregated active power and a representation of aggregated reactive power of the radial power distribution network as observed by the backward-pass ego node, including a sum of power flows on one or more power lines from the backward-pass ego node to the one or more child nodes; and
communicate the one-dimensional explicit voltage representation for the backward-pass ego node from the first computing element to a second computing element of the plurality of computing elements of the distributed computing system.

13. The system of claim 12, the memory including instructions executable by the second computing element to:
access, at the second computing element of the plurality of computing elements, information about a hierarchical structure of a radial power distribution network including:
information about the parent node of the backward-pass ego node of the radial power distribution network and information about one or more child nodes of the parent node, the one or more child nodes of the parent node including the backward-pass ego node; and
the one-dimensional explicit voltage representation for the backward-pass ego node from the first computing element;
and
construct, at the second computing element and based on the one or more child nodes of the parent node, a one-dimensional explicit voltage representation for the parent node that represents a bus voltage magnitude of the parent node in terms of a bus voltage magnitude of a grandparent node of the backward-pass ego node.

14. The system of claim 12, the memory including instructions executable by the plurality of computing elements to:
construct, based on the one or more child nodes of the backward-pass ego node, a one-dimensional explicit angle representation for the backward-pass ego node that represents a bus voltage angle difference between the backward-pass ego node and the parent node in terms of the bus voltage magnitude of the parent node, the one-dimensional explicit angle representation for the backward-pass ego node incorporating a representation of aggregated active power and a representation of aggregated reactive power of the radial power distribution network as observed by the backward-pass ego node, including a sum of power flows on one or more power lines from the backward-pass ego node to the one or more child nodes; and
communicate the one-dimensional explicit angle representation for the backward-pass ego node to the second computing element of the distributed computing system.

15. The system of claim 14, the memory including instructions executable by the plurality of computing elements to:
access, at the second computing element of the plurality of computing elements, information about a hierarchical structure of a radial power distribution network including:
information about the parent node of the backward-pass ego node of the radial power distribution network and information about one or more child nodes of the parent node, the one or more child nodes of the parent node including the backward-pass ego node; and
the one-dimensional explicit angle representation for the backward-pass ego node from the first computing element;
and
construct, at the second computing element and based on the one or more child nodes of the parent node, a one-dimensional explicit angle representation for the parent node that represents a bus voltage angle of the parent node in terms of a bus voltage magnitude of a grandparent node of the backward-pass ego node.

16. The system of claim 12, the memory including instructions executable by the plurality of computing elements to:
access, at the first computing element and from a third computing element of the plurality of computing elements, a one-dimensional explicit voltage representation for a child node of the one or more child nodes of the backward-pass ego node, the one-dimensional explicit voltage representation for the child node being in terms of a bus voltage magnitude of the backward-pass ego node; and
determine, at the first computing element, a representation of aggregated active power and a representation of aggregated reactive power of the radial power distribution network as observed by the backward-pass ego node based on the one-dimensional explicit voltage representation for the child node.

17. The system of claim 12, the memory including instructions executable by the plurality of computing elements to:
access, at the first computing element of the distributed computing system and from a third computing element of the plurality of computing elements, a one-dimensional explicit angle representation for a child node of the one or more child nodes of the backward-pass ego node, the one-dimensional explicit angle representation for the child node being in terms of a bus voltage magnitude of the backward-pass ego node; and
determine a representation of aggregated active power and a representation of aggregated reactive power of the radial power distribution network as observed by the backward-pass ego node based on the one-dimensional explicit voltage representation for the child node.

18. A non-transitory computer readable medium comprising instructions that are executable by one or more processors to:
access information about a hierarchical structure of a radial power distribution network;
sequentially construct, starting with a leaf node of the radial power distribution network as a backward-pass ego node and propagating in a backward direction towards a substation bus of the radial power distribution network:
a one-dimensional explicit voltage representation that represents a bus voltage magnitude of the backward-pass ego node in terms of a bus voltage magnitude of a parent node of the backward-pass ego node; and
a one-dimensional explicit angle representation that represents a bus voltage angle difference between the backward-pass ego node and the parent node in terms of the bus voltage magnitude of the parent node; and
sequentially evaluate, starting with a child node of the substation bus of the radial power distribution network as a forward-pass ego node and propagating in a forward direction towards the leaf node of the radial power distribution network:
a bus voltage magnitude of the forward-pass ego node based on substitution of an evaluated bus voltage magnitude of the parent node into the one-dimensional explicit voltage representation for the forward-pass ego node; and
a bus voltage angle of the forward-pass ego node based on substitution of the evaluated bus voltage magnitude of the parent node into the one-dimensional explicit angle representation for the forward-pass ego node.

19. The non-transitory computer readable medium of claim 18, further comprising instructions that are executable by one or more processors to:
access information about a hierarchical structure of a radial power distribution network including information about the backward-pass ego node of the radial power distribution network and one or more child nodes of the backward-pass ego node;
construct, at a first computing element in communication with the non-transitory computer readable medium and based on the one or more child nodes of the backward-pass ego node, a one-dimensional explicit voltage representation for the backward-pass ego node that represents a bus voltage magnitude of the backward-pass ego node in terms of a bus voltage magnitude of a parent node of the backward-pass ego node, the one-dimensional explicit voltage representation for the backward-pass ego node incorporating a representation of aggregated active power and a representation of aggregated reactive power of the radial power distribution network as observed by the backward-pass ego node, including a sum of power flows on one or more power lines from the backward-pass ego node to the one or more child nodes; and
communicate the one-dimensional explicit voltage representation for the backward-pass ego node from the first computing element to a second computing element.

20. The non-transitory computer readable medium of claim 19, further comprising instructions that are executable by one or more processors to:
access, at the first computing element and from a third computing element, a one-dimensional explicit angle representation for a child node of the one or more child nodes of the backward-pass ego node, the one-dimensional explicit angle representation for the child node being in terms of a bus voltage magnitude of the backward-pass ego node; and
determine a representation of aggregated active power and a representation of aggregated reactive power of the radial power distribution network as observed by the backward-pass ego node based on the one-dimensional explicit voltage representation for the child node.
